(19) United States
(12) Patent Application Publication
(10) Pub. No.: US 2025/0369880 A1
(43) Pub. Date: Dec. 4, 2025

(54) METHOD FOR ADAPTING REFRACTIVE INDEX

(71) Applicant: tooz technologies GmbH, Aalen (DE)

(72) Inventors: Georg MICHELS, Georg (DE); Michael POLLMANN, Königsbronn (DE); Huang Min CHEN, Aalen (DE)

(73) Assignee: tooz technologies GmbH, Aalen (DE)

(21) Appl. No.: 18/860,796

(22) PCT Filed: Apr. 28, 2023
(86) PCT No.: PCT/EP2023/061280

§ 371 Date: Aug. 15, 2025

(30) Foreign Application Priority Data
Apr. 29, 2022 (DE) 10 2022 110 540.7

(51) Int. Cl. G01N 21/41; C09J 163/00; C09J 169/00

(52) U.S. Cl. CPC G01N 21/41; C09J 163/00; C09J 169/00

(57) ABSTRACT

Various aspects of the disclosure relate to the production of optical components for optical elements used in display devices, such as augmented reality glasses.

### CROSS-REFERENCE TO RELATED APPLICATIONS

This application is a national stage application, filed under 35 U.S.C. § 371, of International Patent Application No. PCT/EP2023/061280, filed Apr. 28, 2023, which claims priority to DE 10 2022 110 540.7, filed Apr. 29, 2022, each of which is incorporated by reference herein in its entirety.

### FIELD OF THE INVENTION

Various aspects of the disclosure relate to the production of optical components for optical elements that are used in display devices, for example smartglasses.

### BACKGROUND OF THE INVENTION

The prior art discloses adhesives suitable as specialized optical fine cement for filling of structures as occur, for example, in smartglasses for embedding of functional layers.

It is a key feature of smartglasses that they introduce virtual content into the field of vision. This typically involves using an injection-molded optical component with various high-precision free-form phases, called a waveguide. A Fresnel structure produced by injection molding, which has a semitransparent coating, serves to display the virtual image to the eye, and the viewer is simultaneously able to perceive the environment through that structure, and this view is not impaired. Alternatively, this structure may also have partial 100% reflective coating. If the regions with 100% mirror reflection are relatively small (for example diameter<1 mm), and the regions in between have sufficiently high transmittance for ambient light, the viewer is likewise able to perceive a virtual image superimposed on the environment.

In order that undisrupted view in horizontal and vertical direction is possible through the prisms or mirror structures disposed in the smart glass, it is useful when the adhesive used has a refractive index very substantially identical to the base material. Furthermore, the adhesive may be part of the optical pathway for the virtual image. For the production of such devices, exact refractive index matching of fine cements to optical components is necessary.

Typically, the optical elements used for the purpose are produced by bonding and combining of optical components, for example transparent shells or overfilled Fresnel structures.

According to WO 2015/121341 A1, adhesives can be produced with optically functional properties, for example a defined refractive index, by using adhesive components with optical quality. A desired refractive index or a desired dispersion (Abbe number) of such adhesives can be adjusted to the desired purpose via the selection of the components used, in particular the chemical structure thereof. The adjustment of the refractive index of adhesives for optical components (fine cement), especially the adjustment of refractive index to an optical component to be bonded, may be made for defined wavelengths (for example in the case of optical measurement systems) or else for a particular wavelength range (e.g. 450 nm-700 nm) in the case of polychromatic applications. In the case of polychromatic adjustment of refractive index, it is important to match the dispersion (wavelength dependence of refractive power) of fine cement and optical components to one another as well as possible. Typically, in such cases, a central wavelength is defined, e.g. 546 nm (nₑ). The dispersion of fine cements can be controlled by the adhesive components used, since the chemical structure of the monomer substances has a considerable influence on refractive power and dispersion.

A specific application is the aforementioned cementing of optical components, some of which have diffractive, reflective and/or other microoptical elements on a component surface. If the refractive index is adjusted to Δn<0.0005, for example, diffractive structures enclosed in the cement layer are virtually no longer visually discernible.

Depending on the structure to be filled and the relative position thereof with respect to viewing direction, there may thus be a need for matching of refractive index between adhesive and base material to the fourth or fifth post-decimal place in order to assure a very substantially undisrupted viewing impression when the user looks through the structure.

Adhesives that meet the abovementioned requirements, for example a permanently constant value in the accuracy described for refractive index, are barely commercially available since, even in the case of identical adhesives, there is usually at least slight fluctuation between individual batches.

It is a complex task to achieve this accuracy in refractive index in synthesis. If the system is a 2-component system (2K system) composed of resin and curing agent, or a mixture of two or more 1K systems, each component on its own should be manufactured in extremely tight tolerances. If batches from different production dates of resin and curing agent are to be used while complying with the maximum permissible index variance in everyday production, there is another increase in complexity and tolerance management.

If the glasses to be bonded or the structures to be filled are produced as optical components in an injection molding method, fluctuations in refractive index in the base glass itself cannot be ruled out. The reason for these fluctuations lies, for example, in the optical properties of the polymer pellets used, which likewise has or may have production-related variations in refractive index. The process regime by the injection molding process results in different refractive indices in the finished component for exactly the same starting material depending on the processing parameters. These may also differ locally within the component. Examples of process parameters here include temperature and shear conditions on melting in the cylinder screw, injection rate, hold pressure profile, cooling time and mold temperature regime, which affect solidification characteristics and hence also local optical properties. Since these parameters also affect the geometric dimensions of the injection molding, they are typically also employed for compensation of fluctuations in the environment and manufacture for compliance with geometric component tolerances. Process-related matching of trueness to scale and refractive index for base glass and adhesive system thus constitutes a particular challenge.

### SUMMARY OF THE INVENTION

There is therefore a need for improved techniques for production of optical elements with exactly matched refractive index.

A method of adjusting the refractive index of an adhesive for an optical element is disclosed, wherein the adhesive is optically transparent and is produced from multiple starting materials, wherein the method comprises:
producing at least one specimen of the optical element using the adhesive,
conducting an optical analysis of the at least one specimen of the optical element with recording of at least one measurement parameter,
adjusting a mixing ratio of the multiple starting materials of the adhesive based on a result of the optical analysis, and
producing multiple repeat products of the optical element using the adhesive with the adjusted mixing ratio of the multiple starting materials.

It is preferably possible in the method of the invention to successively produce multiple specimens of the optical element, where the mixing ratio of the multiple starting materials is matched between the production of the multiple specimens, based on the outcome of the preceding optical analyses of the multiple specimens. The adjustment is preferably effected in a progressive, linear or degressive manner.

The method may further comprise the implementing of a closed-loop control circuit, wherein the closed-loop control circuit compares the at least one measurement parameter with a respective target value and sets a dosage of at least one of the multiple starting materials as controlled variable in the adjusting of the mixing ratio. The closed-loop control circuit can be implemented, for example, by software executed on a processor based on program code from a memory. A corresponding controller may be used. In particular, closed-loop control tolerance of such a closed-loop control circuit as variance from a defined refractive index may be less than 0.0005 or less than 0.0001.

The adhesive may be a two-component adhesive, where the multiple starting materials comprise a first starting material, a second starting material, a third starting material and a fourth starting material, and a first component of the two-component adhesive is mixed from the first starting material and the second starting material, a second component of the two-component adhesive is mixed from the third starting material and the fourth starting material, and the adjusting of the mixing ratio of the multiple starting materials may comprise the adjusting of a first partial mixing ratio of the first starting material relative to the second starting material in the mixing of the first component, and the adjusting of the mixing ratio of the multiple starting materials may comprise the adjusting of a second partial mixing ratio of the third starting material relative to the fourth starting material in the mixing of the second component. Furthermore, the adjusting of the mixing ratio may comprise the adjusting of a third partial mixing ratio of the first component relative to the second component.

In the method of the invention, the first component of the two-component adhesive may be mixed from a first starting material and a second starting material in a first mixer, and the second component of the two-component adhesive may be mixed from a third starting material and a fourth starting material in a second mixer. The first and second components of the two-component adhesive may be mixed in a third mixer downstream of the first and second mixers.

The mixing ratio of the multiple starting materials may be adjusted by varying an amount of at least one starting material of the multiple starting materials, by varying a weight of at least one starting material of the multiple starting materials, by varying a volume of at least one starting material of the multiple starting materials, and/or by varying a flow rate of at least one starting material of the multiple starting materials from a reservoir vessel into a mixing vessel, for example via a metering pump.

In the method of the invention, the at least one measurement parameter may comprise a color splitting and/or an optical displacement of an optical transmission of the optical element, which are determined based on the optical transmission of the test pattern. The at least one measurement parameter may comprise the prismatic effect of the optical element which is determined on the basis of the optical transmission of the test pattern, and/or an optical dispersion of the adhesive at a particular wavelength or within a wavelength range. The optical element may be any kind of micro-and/or macrostructure which, because of its geometric character, in the case of a refractive index of the adhesive that does not meet the conditions, will lead to an optically evaluatable variance in the test image. Typical geometries are: Fresnel structures, prism structures, pyramid structures, striated or corrugated structures, spherical, toric or free-formed curved faces-in coherent or segmented form, individually or in the form of an array, etc. The optical element may preferably comprise a Fresnel structure, and the test pattern in the method may be reflected laterally into the Fresnel structure or the optical element. The Fresnel structure may have, for example, steps along one face, and lateral reflection is then possible into the plane of that face.

In the method of the invention, the optical element may comprise multiple optical components, and the production of the at least one specimen of the optical element may comprise the bonding of multiple optical components with the adhesive and the initiation of curing of the adhesive, where the performance of optical analysis commences before, during or after the initiation of curing.

The producing of the at least one specimen of an optical element comprising multiple optical components may comprise the bonding of multiple optical components with the adhesive and the initiating of curing of the adhesive, wherein a first optical component of the multiple optical components of the optical element comprises a Fresnel structure, and wherein a second optical component of the multiple optical components of the optical element comprises a shell. Alternatively, other kinds of structures, for example prismatic structures, are also conceivable.

### BRIEF DESCRIPTION OF THE DRAWINGS

FIG. 1 shows an illustrative arrangement for performance of optical analysis by the method according to the invention.

FIG. 2 shows a schematic of the effect of variance of refractive index for an illustrative adhesive system on optical analysis of an optical component.

FIG. 3 shows, by way of illustration, effects of inadequate matching of refractive index, which can be used within the scope of optical analysis as measurement parameter for adjustment of refractive index.

FIG. 4 shows a scheme for a structure of a closed loop-controlled process as a configuration of the method of the invention.

FIG. 5 shows a further scheme for a structure of a closed loop-controlled process as a configuration of the method of the invention.

FIG. 6 is a flow diagram of an illustrative method.

### DETAILED DESCRIPTION OF INVENTION

The above-described properties, features and advantages of this invention and the manner in which they are achieved are more clearly and distinctly apparent in association with the description of the working examples that follows, where these are elucidated in detail in association with the drawings.

There follows a detailed elucidation of the present invention by means of preferred embodiments with reference to the drawings. In the figures, identical reference numerals denote identical or similar elements. The figures are schematic representations of various embodiments of the invention. Elements shown in the figures are not necessarily shown true to scale. Instead, the various elements shown in the figures are reproduced such that their function and general purpose will be apparent to the person skilled in the art.

There follows a description of techniques that are used in the production of optical elements. The inventive method for adjustment of refractive index generally comprises the recording of at least one measurement parameter during an optical analysis that enables detection of the quality of the index match for determination of the amounts and mixing ratios of the adhesive in order that the refractive index can be matched as required. In the case of index-matched overfilling of Fresnel structures, a test pattern, for example a black-and-white test pattern (preferably a pattern composed of strips, or a chessboard pattern, etc.), may be observed by means of a camera through a filled structure, and the color splitting or the optical displacement because of the prismatic effect that still exists in the case of a nonoptimal match may be evaluated and used as measurement parameter.

Such techniques can be used to produce optical elements that may be used, for example, in conjunction with smartglasses. Such techniques could also be used, for example, for head-up displays.

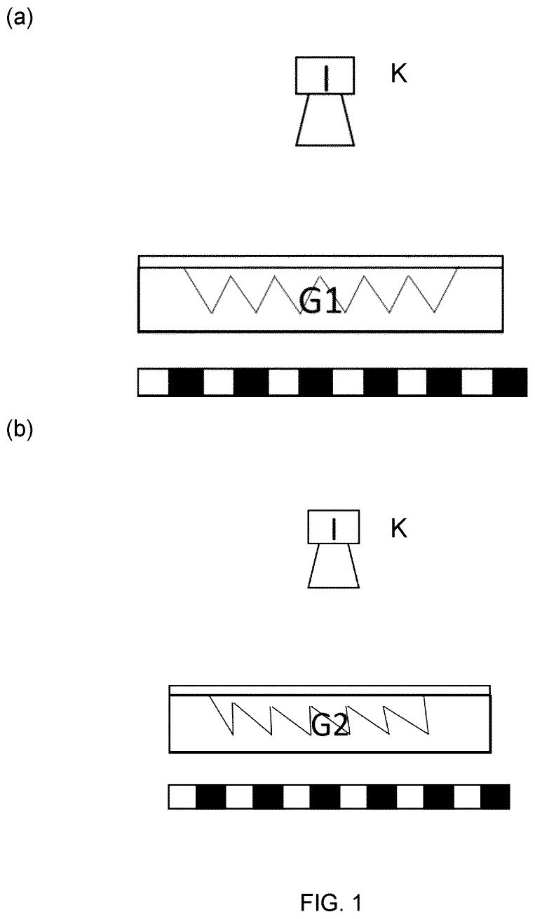

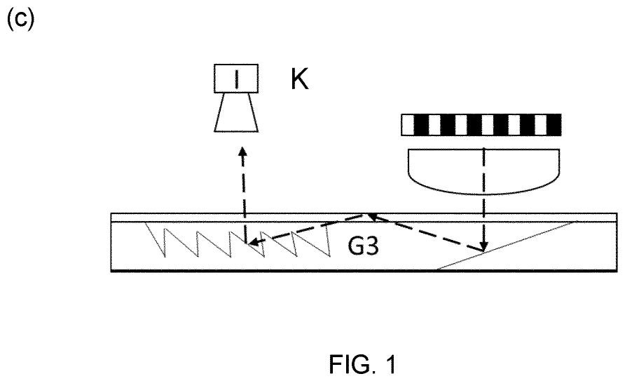

An illustrative arrangement with which the method of the invention can be performed is shown in FIG. 1, wherein a test pattern may be viewed by means of a camera K through a specimen of an optical component or an optical element, for example a specimen made of a filled Fresnel structure G1 (FIG. 1a), G2 (FIG. 1b) or G3 (FIG. 1c), and one or more measurement parameters, for example the color split and/or optical displacement, may be detected and evaluated. This then enables, via variation of the amount of the components of the adhesive, a particular adjustment of refractive index, meaning that index matching can be undertaken or improved. A further working example with regard to the arrangement of specimen, camera and test pattern is shown by way of example in FIG. 1(c): In this case, the light emitted by the test pattern is directed in the camera direction within the waveguide until it is output coupled. In the special case, this light path within the glass may correspond exactly to that in the application as smart glass.

The test pattern itself may also be a self-illuminating object, for example a display, or a non-self-illuminating object.

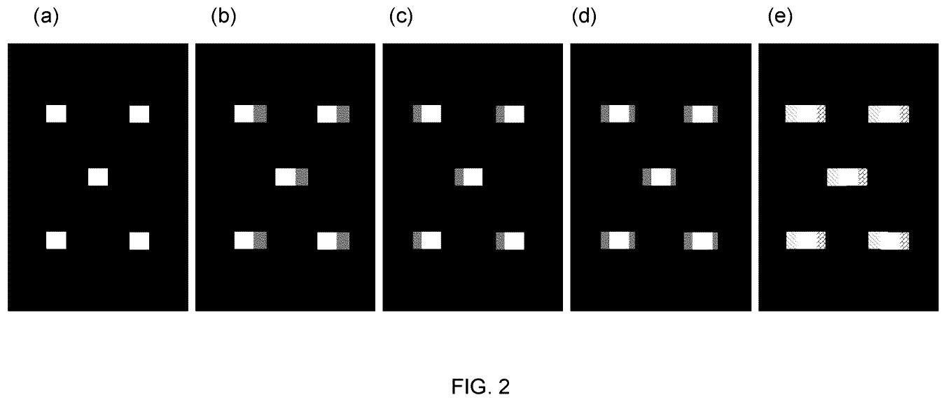

FIG. 2 shows, by way of example, the effect of variance of refractive index for an illustrative adhesive system on an optical component. As well as a displacement from the original image and/or a displaced double image, different (color) splitting is a further measure of the match or mismatch of the refractive indices or Abbe numbers of base material and adhesive, and hence also a measure of the need for adjustment in the refractive index. Thus, direct characterization over the entire visible wavelength range is possible.

In FIG. 2, image a) shows a possible test pattern, and diagrams b) to e) show possible images as observed by a viewer or the camera. In FIG. 2, (a) shows the target image, (b) an image displacement to the left, (c) an image displacement to the right, (d) an image displacement on both sides, and (e) illustrates a color split, for example red to the right, blue to the left or vice versa, etc. This observation can in principle be made before, during or after the curing process. The fully cured state is crucial for final assessment of sufficient matching of refractive indices. However, given sufficient experience with the respective adhesive system, it is possible even on the basis of the image defects of the uncured or only partly cured system or during the progression of curing to conclude the final component quality in the fully cured state. Particularly in the case of very long-lasting curing processes, an early conclusion as to the expected result is particularly valuable in order to be able to balance out process fluctuations in good time via adjustment of the mixing ratios.

Depending on the sign of the differential of the actual and target values of refractive index and the geometric ratios of the structures to be filled, the image taken by the camera, by comparison with the original, may show an image displacement, broadening of the test marks or a color split.

If the images shown in this example in FIG. 2 (b)-(e) represent the final curing state attained, the recording of a measurement parameter corresponding to the offset or color split indicates that the desired index match has not been attained, and so, with further use of the method of the invention, i.e. adjustment of the mixing ratio and production of multiple repeat products of the optical element using the adhesive with the matched mixing ratio, an improved match can be found.

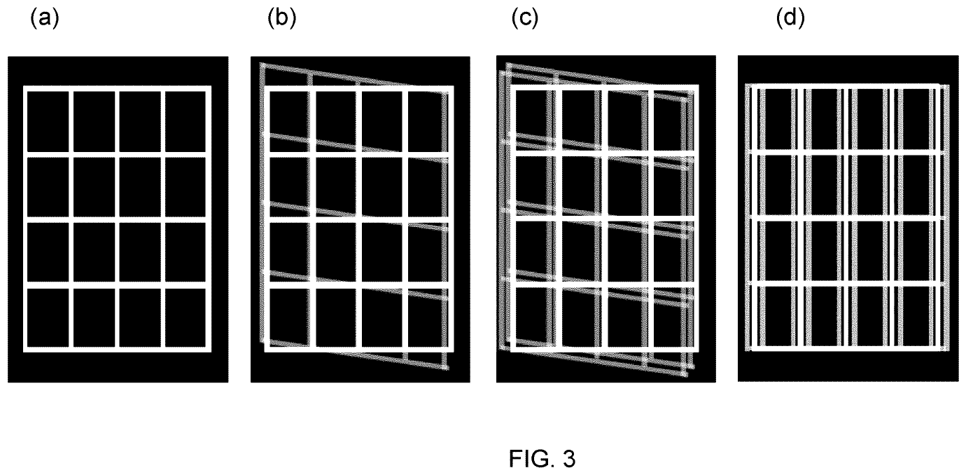

FIG. 3 shows, in analogy to FIG. 2, by way of example, a further test pattern and optical effects as occur in accordance with the geometry ratios in the case of an inadequate index match, and can be employed measurement parameters. Accordingly, FIG. 3 (a) shows the target image, and FIG. 3 (b) to (d) a corresponding image displacement.

As follows from the above observations in relation to FIG. 2 and FIG. 3, in the method of the invention, the at least one measurement parameter may comprise a color split and/or an optical displacement of an optical transmission of the optical element, which are determined on the basis of the optical transmission of the test pattern.

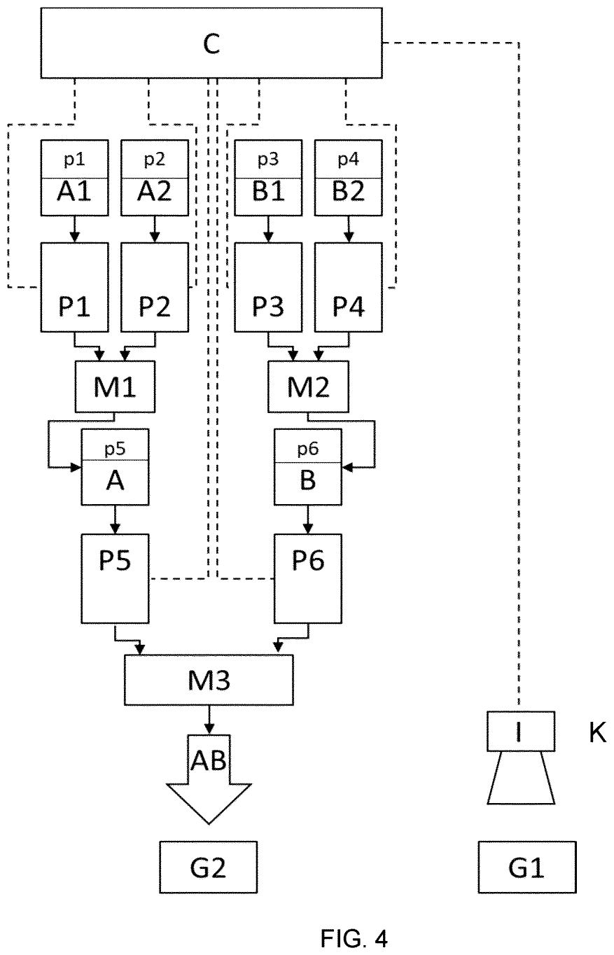

The method may also be executed as a closed loop-controlled process. As an example, the structure shown in schematic form in FIG. 4 is to be elucidated, which consists of the arrangement described hereinafter.

As described above, the transparent adhesive used is formed from multiple starting materials, which may be a two-component (2K) adhesive. For example, the first and second starting materials A1 and A2 may form the resin component A, and the third and fourth starting materials B1 and B2 the curing agent component B.

In the example described in FIG. 4, a first component A of the two-component adhesive is mixed from a first starting material A1 and a second starting material A2, and a second component B of the two-component adhesive is mixed from a third starting material B1 and a fourth starting material B2. In so doing, matching of the mixing ratio of the multiple starting materials is undertaken, i.e. of a first partial mixing ratio (A1):(A2) of the first starting material A1 relative to the second starting material A2 in the mixing of the first component A, and matching of the mixing ratio of the multiple starting materials of a second partial mixing ratio (B1):(B2) of the third starting material B1 relative to the fourth starting material B2 in the mixing of the second component B.

In the execution shown in FIG. 4, the reservoir vessels for the starting materials A1/A2 contain the starting materials for the resin A, i.e. the first and second starting materials A1 and A2 that form the resin A, and arrive in the reservoir vessel A after being mixed in the mixer M1. The reservoir vessels B1/B2 contain the abovementioned starting materials for component B of the adhesive, i.e. the third and fourth starting materials B1 and B2, which arrive in the reservoir vessel B after being mixed in the mixer M2. The components A and B together form the reactive system which is cured thermally and/or photochemically/by UV activation over time, where the components in the example shown come into contact in the mixer M3. The reservoir vessels may be under the pressures p1 to p6, in order to ensure the desired feeding into the metering pumps P1 to P6. The metering pumps are responsible for the exact adjustment of the mixing ratios in their downstream mixer systems or mixers M1 to M3, and can be correspondingly controlled by a controller unit C. For example, the mixer M1 may be configured for the mixing of the starting materials A1 and A2, and the mixer M2 may be configured for the mixing of the starting materials B1 and B2, which respectively arrive via the pumps P5 and P6 in the mixer M3, which is configured for the mixing of the components A (here:resin) and B (here: curing agent). Thus, the adhesive AB is obtained in reactive form. The method of the invention may also comprise the adjustment of a third partial mixing ratio of the first component A relative to the second component B.

The control commands for the metering pumps can be generated from the optical analysis mentioned, i.e. an optical performance analysis, and a closed-loop control circuit can be constructed in this way. The change in the mixing ratios results in altered reactivity between the components, for example between the resin and curing agent of a 2K adhesive. It is possible here to adjust the amounts of at least one starting material by varying the weight, by varying a volume and/or by varying a flow rate of at least one starting material of the multiple starting materials into a reservoir vessel.

The adjusting of the mixing ratio can be controlled via a closed-loop control system, where the closed-loop control uses the amount of the adhesive components or starting materials that are mixed with a further adhesive component or starting material as the manipulated variable.

The components may themselves in turn be formed from multiple components, or constituents or starting materials. The first and second starting materials A1 and A2 mentioned for component A may be variants of the same chemical material, for example of the resin in this case, and differ, for example, in the refractive index in the region of the third or fourth post-decimal place. The difference may, as mentioned above, be a result of the production, or may be deliberately set such that one of the two variants lies below and the other above the target value for the refractive index to be established for component A. By means of metering pumps, the appropriate mixing ratio of A1 and A2 can be established, such that A can be adjusted exactly to a currently required refractive index. As mentioned at the outset, components A1 and A2 may also be different adhesives, for example two different 1K adhesives.

The manner in which the refractive index is controlled for component A can also be applied to component B, which may especially be the curing agent of a 2K adhesive. If the starting materials B1 and B2 differ, for example, in viscosity and/or reactivity, precise adjustment of the curing agent component B in accordance with demand is possible here too.

In combination with the second component B of the reactive system, which is the curing agent here, which in the above example is mixed from the third and fourth starting materials B1 and B2, the refractive index matched finally to the optical component or to the component part results from mixing of components A and B.

Specifically for thermally curing systems, it is frequently the case that two opposing effects occur. The viscosity decreases with higher temperature, which is often desirable in order to form a thin, uniform adhesive gap, and, on the other hand, the curing process is accelerated, which can lead to stresses and warpage depending on the temperature gradient being established in the component or adhesive gap, which can in turn adversely affect the optical performance of the component or optical element. It is thus the case here too that a practical means of adjustment of viscosity and/or reactivity is desirable. Such changes also affect the refractive index of the overall system A+B, which is then compensated for by the above-described readjustment of the mixing ratio of the starting materials (referred to hereinafter as A1 and A2). For example, the resin component (referred to above as A) can affect the optical properties, and the curing agent component B can affect the processing properties. The components with their different properties, for example a refractive index that differs from batch to batch (i.e. varies because of production) in the starting material (referred to hereinafter as A1 or A2), can be mixed as required.

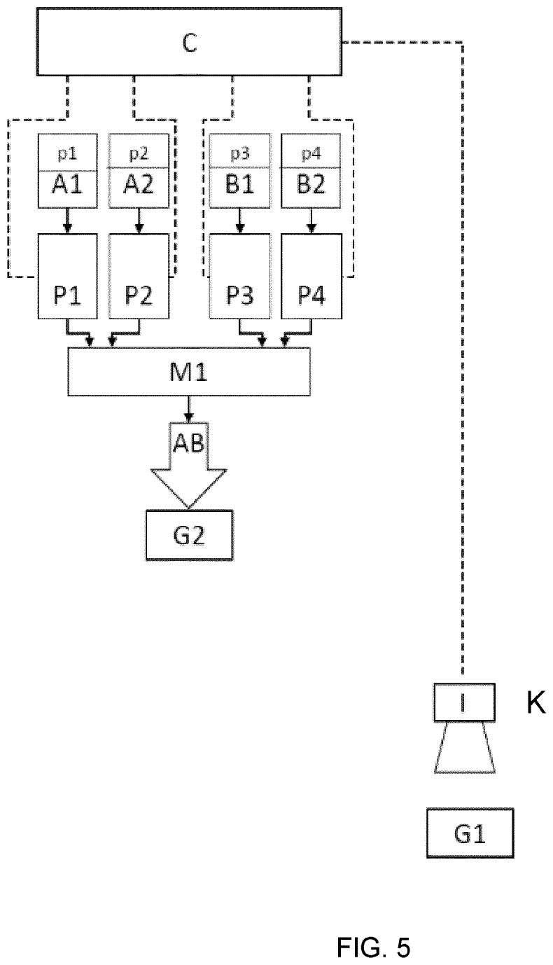

It is possible here for the method to include the recording of the quality of the index match for determination of the individual volume flow rates and mixing ratios to be established via the controller C (for example that shown in the illustrative arrangements in FIGS. 4 and 5). Such an execution may further comprise the implementing of a closed-loop control circuit, wherein the closed-loop control circuit compares the at least one measurement parameter with a respective target value and sets a dosage of at least one of the multiple starting materials as controlled variable in the adjusting of the mixing ratio.

As described above, in the case of index-matched overfilling of Fresnel structures, for example, a black-and-white test pattern (stripes, chessboard pattern, etc.) can be viewed by means of a camera through the filled optical component (Fresnel structure) as specimen (referred to in the figures as G1, G2 and G3). The color split or the optical displacement because of the prismatic effect that still exists in the case of a nonoptimal match is evaluated and used as measurement parameter for the index match. An illustrative arrangement for an optical analysis is shown in FIGS. 1, 4 and 5.

It is also possible to use different analysis methods for construction of the closed-loop control circuit by comparison with the above-described analysis methods.

The method of the invention can advantageously be formed as a process wherein a closed-loop control circuit is constructed. For instance, the method may comprise the implementing of a closed-loop control circuit, wherein the closed-loop control circuit compares the at least one measurement parameter with a respective target value and sets a dosage of at least one of the multiple starting materials as controlled variable in the adjusting of the mixing ratio. This is applicable both to the mixing of the components, for example resin and curing agent, and to the starting materials of the resin component and curing agent component.

Further sub-configurations proceeding from the above-described construction are likewise conceivable, as elucidated by the following example:

The construction described so far for a 2-component system also includes application to a 1-component system, for example UV-curing 1-component adhesives, or mixtures thereof. Here too, it is extremely difficult but necessary to establish a perfect index match and also to track process-related index fluctuations (for example in the polymer used for the base material). In a variant of the invention shown in FIG. 5, by comparison with FIG. 4, there is no mixing of the starting materials A1 and A2 to give A and B1 with B2 to give B, and all components A1, A2, B1 and B2 are metered directly into just one common mixer unit M1. The refractive index of the overall system is subject to closed-loop control in terms of volume ratios according to the requirements via variation of the volume flow rate of the starting materials A1, A2, B1 and/or B2 individually or collectively. Accordingly, it is also possible to feed the first and second starting materials A1 and A2 directly into the mixer M1 via pumps P1 and P2, and likewise the starting materials B1 and B2 via pumps P3 and P4, where the filled optical component G2, which may be a Fresnel structure, is obtained after A and B have been mixed.

FIG. 5 shows a simplified arrangement as an example for execution of the method of the invention. G1 illustrates a specimen that may comprise a filled structure of an optical component, for example a filled Fresnel structure as optical component or constituent of an optical element. The camera K is used to subject specimen G1 to an optical analysis with recording of at least one measurement parameter, with optional additional use, as mentioned above, of a pattern for the optical analysis. In the variant shown in FIG. 5, the components (for example resin and curing agent, referred to hereinafter as A and B) are fed directly to the mixer M1, and not kept ready as separate components A and B via separate streams in mixers Ml and M2 (cf. FIG. 4). In analogy to the arrangement shown in FIG. 4-controlled by the controller C and determined by the analysis result from specimen G1—the first and second starting materials A1 and A2 (which, for example, when mixed, give the resin A)—optionally under pressures p1 and p2—are fed to the mixer M1 through pumps P1 and P2. The third and fourth starting materials B1 and B2 (which, for example, when mixed, give the curing agent B)—optionally under pressures p3 and p4—are fed through pumps P3 and P4 to the mixer M1, in which the mixing to give the adhesive AB is then effected, which is processed to give the filled structure G2. Optionally, the structure G2 may then—by comparison with structure G1—be subjected to parallel or subsequent optical analysis in order to perform index matching. Structures G1 and G2 may be any kind of micro-and/or macrostructure which, because of its geometric character, in the case of a refractive index of the adhesive that does not meet the conditions, will lead to an optically evaluatable variance in the test image. Typical geometries are: Fresnel structures, prism structures, pyramid structures, striated or corrugated structures, spherical, toric or free-formed curved faces-in coherent or segmented form, individually or in the form of an array, etc.

As mentioned above, the refractive index may be adjusted via variations in the weight or feed rate or volume of the components of the adhesive.

In this way, the refractive index can be adjusted during the production process, and exact adjustment and readjustment can be effected by the method of the invention. Preference is given to influencing by means of a controller (control unit) C, as shown in FIGS. 4 and 5.

Adhesives used in the method of the invention may, for example, be a composition based on epoxy resins and thiols, which can be polymerized under amine catalysis.

In the case of adhesives, especially construction adhesives, that are used in fine mechanics and optics, there is increasingly a need for short curing times. Reactive adhesives having short curing times typically also have short processing times. From a technological point of view, however, sufficiently long processing times are frequently required, for example in order to exactly align the workpieces to be bonded. Commercial adhesives that cure at room temperature are polyurethane adhesives and amine-cured epoxy resins. In the case of a processing time of about one hour, the curing time at room temperature until attainment of final strength is in the range from about one to two days.

The method of the invention for adjusting refractive index is especially suitable for an optical element, in which optical components and parts thereof are bonded to one another by the adhesive mentioned, and the adhesive becomes part of the optical system.

In the method of the invention, an adhesive or a composition with short curing time may be used when the processing time is at the same time sufficiently long, such that complete curing is effected even at room temperature and the microcement has excellent bond strengths.

An adhesive usable in the method of the invention can be inferred, for example, from DE 10 2012 210 185 A1, WO 2009/056196 A1 or WO 2015/121341 A1. In this way, the individual parts of an optical component, or optical components, may be bonded to one another by means of an adhesive or adhesive system based on amine-catalyzed thiol curing of epoxy resins analogously to WO 2015/121341 A1, especially that analogous to claims 1 to 9, and especially preferably analogous to claim 1, of WO 2015/121341 A1. The processing can be conducted, for example, at a temperature from a range from 20° C. to 80° C., preferably from a range from 40° C. to 70° C. and more preferably from a range from 45° C. to 65° C.

The starting material used for an adhesive usable in the method of the invention, analogously to WO 2015/121341 A1, may be a tertiary amine.

An adhesive composition usable in the method of the invention may be UV-curable and contain a photolatent base, as described, for example, in claim 9 of WO 2015/121341 A1. The photolatent base in the context of the invention means the photolatent base compound according to claim 1 of EP 2 145 231 B1, to which reference is made in the present context. A photoinitiator in the context of the invention is a chemical compound that breaks down to reactive fragments through absorption of light. These reactive fragments then detach the protective group from the photolatent base in the composition, so as to form a highly basic amidine structure from the photolatent base, which, as base, catalyzes the polymerization reaction between the epoxide and the SH group of the thiol ester. In this way, the amine-catalyzed thiol reaction with the epoxide is accelerated locally in the region of action of UV light, which greatly shortens the curing time of the composition.

In addition to the photoinitiator, a dye may be present.

When the composition according to WO 2015/121341 A1 is used as embedding medium or for bonding of glasses, it is advantageous when the composition additionally contains an alkoxysilane that optionally additionally has a polymerizable group.

Moreover, the composition according to WO 2015/121341 A1 may additionally contain plasticizers, solid plasticizers, synthetic resins and/or polymers, for example ethylene-vinyl acetate (EVA) copolymers. In addition, it is possible to use fillers such as ground quartzes (Silbond) and finely divided silica as additives.

The resin component of the fine cement, and also the curing agent, should preferably be reproducible to the specified accuracy. In order to achieve this accuracy, for the method of the invention, preference is given to using at least two main constituents, e.g. thiol esters or thiourethanes, having different refractive indices for the resin component (for example an epoxy compound, component (A)) and/or for the curing agent component (for example a thiol ester (B) or oligomeric thiourethane).

The compositions described in WO 2015/121341 A1 for fine cement having high refractive index adjustment have been found to be particularly suitable. It is advantageous here to use the oligomers described above or in this document, especially the oligomeric thiourethanes (reduced volume shrinkage, low stresses on curing, matched viscosity to the resin component—and hence better miscibility of resin and curing agent).

The method of the invention can be implemented as follows, for example, in a method of producing an optical element which is transparent to a predetermined wavelength range and in which an optically active structure is embedded, having the following steps:
a) providing a first shell transparent to the predetermined wavelength range, which is in one-piece form and has a structured section on its top side,
b) applying a coating which is optically active for the predetermined wavelength range atop the structured section in order to form the optically active structure,
c) providing a second shell transparent to the predetermined wavelength range, which is in one-piece form and which has a bottom side having a shape complementary to the shape of the top side of the first shell, with or without a complementary structure to the first shell,
d) applying a composition transparent to the predetermined wavelength range as adhesive on the top side of the first shell and/or bottom side of the second shell, and
e) bonding the top side of the first shell to the bottom side of the second shell by means of the adhesive,
wherein the refractive index of the optical element is matched by the method of the invention, such that a two-shell optical element is produced, in which the optically active structure is embedded.

As described above, the optically active structure may be a Fresnel structure. As mentioned at the outset, the optically active structure may be any kind of micro- and/or macrostructure which, because of its geometric character, in the case of a refractive index of the adhesive that does not meet the conditions, will lead to an optically evaluatable variance in the test image. Typical geometries are: Fresnel structures, prism structures, pyramid structures, striated or corrugated structures, spherical, toric or free-formed curved faces—in coherent or segmented form, individually or in the form of an array, etc.

Such a method can be used to produce an optical element having two or more shells (especially having exactly two shells) with the desired accuracy in a large number of items and with suitable optical properties. The optical element may also have more than two shells and two or more parts that are bonded or joined to one another with the adhesive.

The first shell may be provided in step a) such that the top side takes the form of a smooth face apart from the structured section.

In addition, after step b), at least one depression formed by the structured section may be filled with material up to the top side. Preference is given to using the same material from which the first shell is formed. In addition, the composition described can be used for filling.

The filling can be conducted in one step or in multiple filling steps. In particular, the filling is conducted so as to give a smooth continuous top side. The filled structured section thus forms a continuous face together with the rest of the top side.

In the method mentioned, based on WO 2015/121341 A1, in step d), the adhesive having the refractive index that has been matched by the method of the invention can be applied as adhesive layer over the entire top side of the first shell and/or the entire bottom side of the second shell. In particular, it is also possible to provide the structured section (preferably when it has been filled with material up to the top side) with the adhesive layer.

The first shell may be composed of a first polymer material, and the second shell may in each case be selected from one or more of a thermoplastic material, a thermoset material, mineral materials and a combination of polymer material and mineral glasses.

The optically active structure may, as described in WO 2015/121341 A1, take the form, for example, of a reflective and/or diffractive structure. In particular, the optically active structure may take the form of a partly reflective structure and/or wavelength-dependent reflective structure. The forming of the first and/or second shell may especially in each case be conducted in at least two successive component steps. This leads to reduced shrinkage in the production of the first or second shell. In the structure described, for example, the first and second polymer materials used are those materials having refractive indices for at least one wavelength from the predetermined wavelength range that differ by not more than 0.005, preferably not more than 0.002, more preferably not more than 0.0005, even more preferably not more than 0.0001. In particular, the refractive indices may differ by not more than 0.00005. In the case of such a small difference in refractive index, the interface between the two polymer materials for the predetermined wavelength range effectively disappears from view.

The polymer materials here may be chosen such that they have the same dispersion in the predetermined wavelength range. The predetermined wavelength range may be the visible wavelength range, the near-infrared range, the infrared range and/or the UV range.

Using the method according to the present invention, it is possible, for example, to produce an optical element by the procedure described in WO 2015/121341 A1 such that, for example, in a first step, a first semifinished product is produced from a thermoplastic polymer by injection molding. The first semifinished product has a first side and a second side. On the second side, a microstructure is formed, which defines the shape of the desired reflective facets.

The materials used for the two semifinished products may be different materials. Preferably, however, the same material is used for both semifinished products. In particular, the aforementioned thermoplastic materials and/or thermoset materials are suitable.

With the adhesives described in WO 2015/121341 A1, it is possible to achieve sufficiently long processing times of about 60-120 min in the case of complete through-curing within about 4-6 hours (at room temperature), and excellent bond strengths are achievable.

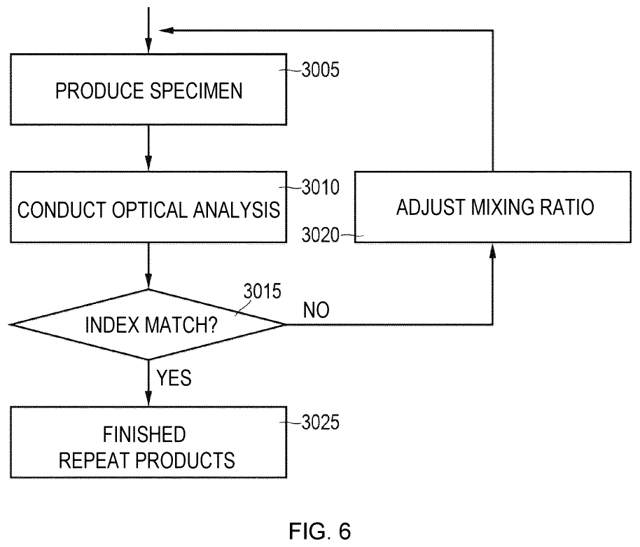

FIG. 6 is a flow diagram of an illustrative method of adjusting the refractive index of an adhesive for an optical element.

In box 3005, a specimen of the optical element is produced. For this purpose, multiple optical components of the optical element may be bonded to one another. For this purpose, an optically transparent adhesive is used, as described above. This optically transparent adhesive has multiple starting materials that are mixed with one another. In the first iteration of box 3005, an initial mixing ratio of the multiple starting materials is used.

For example, in box 3005, it is possible to perform a technique as in association with FIG. 4 in order to conduct the mixing, where, as mentioned above, the first and second starting materials A1 and A2 that form resin A arrive in reservoir vessel A after being mixed in the mixer M1, and the third and fourth starting materials B1 and B2 arrive in reservoir vessel B after being mixed in the mixer M2. The components A and B together form the reactive system which is cured thermally and/or photochemically/by UV activation over time, where the components in the example shown come into contact in the mixer M3.

In addition, in box 3005, a technique as in association with FIG. 5 may be implemented, where, by comparison with FIG. 4, as mentioned above, the components (for example resin and curing agent, referred to above as A and B) are fed directly to the mixer M1, and not kept ready as separate components A and B via separate streams in mixers M1 and M2. In analogy to the arrangement shown in FIG. 4—controlled by the controller C and determined by the analysis result from specimen G1—the first and second starting materials A1 and A2 (which, for example, when mixed, give the resin A)—optionally under pressures p1 and p2—are fed to the mixer M1 through pumps P1 and P2. The third and fourth starting materials B1 and B2 (which, for example, when mixed, give the curing agent B)—optionally under pressures p3 and p4—are fed through pumps P3 and P4 to the mixer M1, in which the mixing to give the adhesive AB is then effected, which is processed to give the filled structure G2.

The mixing ratio of the starting materials determines the refractive index. In particular, the refractive index at the initial mixing ratio may vary from the refractive index of the substrate material which is used for one or more of the optical elements. This may be the case because of fluctuations in substrate material batches and/or because of fluctuations in the mixing ratio of the starting materials. The ambient conditions can also affect the quality of matching of the refractive index.

In box 3010, an optical analysis of the specimen that has been produced in the present iteration of box 3005 is conducted. The optical analysis serves the purpose of determining the quality of matching of the refractive index between adhesive and optical components. For example, in box 3010, as mentioned above, it is possible to conduct an optical analysis with recording of the at least one measurement parameter, as shown, for example, in FIGS. 1, 4 and 5. In particular, in box 3010, as shown in FIGS. 4 and 5, an optical analysis of the specimen G1, which may comprise, for example, a filled Fresnel structure as optical component, can be conducted with camera K, with recording of at least one measurement parameter, where it is optionally the case, as mentioned above, that the transmission of a pattern through a camera can be used for the optical analysis. The verification technique described in box 3010 can also evaluate the result of the optical analysis, for example the color split shown in FIG. 2 and FIG. 3 or the optical displacement.

In box 3015, it is then verified whether there is an index match or not, i.e. whether the refractive index of the adhesive varies from the refractive index of the optical components that form the optical element. For example, it is possible to verify whether there is a variance within a defined tolerance range, such that the mixing ratio of the multiple starting materials can be adjusted between the production of the multiple specimens-preferably in a progressive, linear or degressive manner—based on the outcome of the evaluation of the preceding optical analyses of the multiple specimens, for example of the optical offset or of the color split, as shown in FIG. 2 and FIG. 3.

When the result of the verification in box 3015 is that the refractive index of the adhesive varies significantly from the refractive index of the optical components, it is possible to adjust the mixing ratio of the starting materials in box 3020. This could be effected, for example, by closed-loop control. For example, in the case of such an adjustment of the closed-loop control, it would be possible to take account of a sign of the variance and/or a size of the variance and translate it by means of a defined model, in an adjustment of the mixing ratio of one or more starting materials in relation to one or more other starting materials. For example, there could be a trend of a greater adjustment in the mixing ratio in the event of a greater variance in the refractive indices. The specific implementation of the adjustment of the mixing ratio depends on the nature of the adhesive used or on the starting materials used. For example, it would be possible to ascertain such a dependence in empirical tests. It would be possible to model such logic by means of a controller, which, on the basis of program code from a memory executed by the controller, actuates a metering pump for example. In this way, in particular, it is possible to implement a closed-loop control circuit that minimizes the refractive index mismatch and uses the mixing ratio of the starting materials as manipulated variable. Such a closed-loop control circuit can work with particularly high latency because, for example, the optical analysis has to await a stable state after initiation of the curing of the adhesive.

If, however, the curing characteristics are known, readjustment is already possible on the basis of the variance found in the uncured state. In that case, the target parameter would be a particular offset or a particular color split equal to after the applying of the adhesive system or in a defined partly cured state.

With the matched mixing ratio, there is then verification in a further iteration of boxes 3005, 3010, 3015 as to whether there is an index match. What this means is thus that multiple specimens can be produced (for example in a progressive, linear or degressive manner), where the matching of the mixing ratio of the multiple starting materials is effected between the production of two specimens (in successive iterations of boxes 3005, 3010, 3015), in each case with respect to the outcome of a corresponding optical analysis from the preceding iteration.

When the verification in box 3015 ultimately shows that the refractive index of the adhesive does not vary significantly, if at all, from the refractive index of the optical components, i.e. there is a successful index match, it is possible in box 3025 to produce finished repeat products with the desired optical properties.

Using the above-described method of the invention, it is possible to produce an optical element for a display device or a pair of smartglasses that comprises multiple optical components and is transparent or partly transparent to a predetermined wavelength range, and in which an optically active structure is embedded, where the method of the invention enables matching of the refractive index, such that an undistorted view through the optical element is possible.

1. A method of adjusting the refractive index of an adhesive for an optical element, wherein the adhesive is optically transparent and is produced from multiple starting materials, wherein the method comprises:
producing at least one specimen of the optical element using the adhesive,
conducting an optical analysis of the at least one specimen of the optical element with recording of at least one measurement parameter,
adjusting a mixing ratio of the multiple starting materials of the adhesive based on a result of the optical analysis, and
producing multiple repeat products of the optical element using the adhesive with the adjusted mixing ratio of the multiple starting materials.

2. The method as claimed in claim 1,
wherein multiple specimens of the optical element are produced successively,
wherein the mixing ratio of the multiple starting materials is adjusted between the producing of the multiple specimens, based on the outcome of the preceding optical analyses of the multiple specimens.

3. The method as claimed in claim 2, wherein the method further comprises:
implementing a closed-loop control circuit, wherein the closed-loop control circuit compares the at least one measurement parameter with a respective target value and sets a dosage of at least one of the multiple starting materials as controlled variable in the adjusting of the mixing ratio.

4. The method as claimed in claim 3,
wherein a closed-loop control tolerance of the closed-loop control circuit as variance from a defined refractive index is less than 0.0005 or less than 0.0001.

5. The method as claimed in claim 1,
wherein the multiple starting materials comprise a first starting material, a second starting material, a third starting material and a fourth starting material,
wherein the adhesive is a two-component adhesive,
wherein a first component of the two-component adhesive is mixed from the first starting material and the second starting material,
wherein a second component of the two-component adhesive is mixed from the third starting material and the fourth starting material,
wherein the adjusting of the mixing ratio of the multiple starting materials comprises the adjusting of a first partial mixing ratio of the first starting material relative to the second starting material in the mixing of the first component,
wherein the adjusting of the mixing ratio of the multiple starting materials comprises the adjusting of a second partial mixing ratio of the third starting material relative to the fourth starting material in the mixing of the second component.

6. The method as claimed in claim 5,
wherein the adjusting of the mixing ratio comprises the adjusting of a third partial mixing ratio of the first component relative to the second component.

7. The method as claimed in claim 1,
wherein the multiple starting materials comprise a first starting material, a second starting material, a third starting material and a fourth starting material,
wherein the adhesive is a two-component adhesive,
wherein the first component of the two-component adhesive is mixed from the first starting material and the second starting material in a first mixer, and
wherein the second component of the two-component adhesive is mixed from the third starting material and the fourth starting material in a second mixer,
and wherein the first and second components of the two-component adhesive are mixed in a third mixer downstream of the first and second mixers.

8. The method as claimed in claim 1,
wherein the mixing ratio of the multiple starting materials is adjusted by varying an amount of at least one starting material of the multiple starting materials, by varying a weight of at least one starting material of the multiple starting materials, by varying a volume of at least one starting material of the multiple starting materials, and/or by varying a flow rate of at least one starting material of the multiple starting materials from a reservoir vessel into a mixing vessel, for example via a metering pump.

9. The method as claimed in claim 1,
wherein the performing of the optical analysis comprises the recording of a temporal evolution of the at least one measurement parameter over a period of at least 24 hours.

10. The method as claimed in claim 1,
wherein the performing of the optical analysis comprises the detecting of an optical transmission of a test pattern through the optical element by means of a camera

11. The method as claimed in claim 9,
wherein the at least one measurement parameter comprises a color splitting and/or an optical displacement of an optical transmission of the optical element, which are determined based on the optical transmission of the test pattern.

12. The method as claimed in claim 9,
wherein the at least one measurement parameter comprises the prismatic effect of the optical element which is determined based on the optical transmission of the test pattern.

13. The method as claimed in claim 9,
wherein the optical element comprises a Fresnel structure, and
wherein the test pattern is reflected laterally into the Fresnel structure.

14. The method as claimed in claim 1,
wherein the at least one measurement parameter comprises an optical dispersion of the adhesive at a particular wavelength or within a wavelength range.

15. The method as claimed in claim 1,
wherein the optical element comprises multiple optical components,
wherein the producing of the at least one specimen of the optical element comprises the bonding of the multiple optical components with the adhesive and the initiating of curing of the adhesive,
wherein the performance of the optical analysis commences after the initiation of curing.

16. The method as claimed in claim 1,
wherein the optical element comprises multiple optical components,
wherein the producing of the at least one specimen of the optical element comprises the bonding of multiple optical components with the adhesive and the initiating of curing of the adhesive,
wherein a first optical component of the multiple optical components of the optical element comprises a Fresnel structure, and
wherein a second optical component of the multiple optical components of the optical element comprises a shell.

17. The method as claimed in claim 16, wherein the first optical component is a shell comprising the Fresnel structure.

18. The method as claimed in claim 15, wherein one or more of the optical components have been produced by the injection molding method.

19. The method as claimed in claim 1, wherein a curing reaction of the adhesive is initiated by means of UV light and/or thermally.

20. The method as claimed in claim 1,
wherein the adhesive is a thermally curing or photochemically curing (UV-curing) adhesive.

21. The method as claimed in claim 1, wherein the adhesive is produced from multiple 1-component adhesives as starting materials.

22. The method as claimed in claim 1, wherein the adhesive comprises an epoxy resin that cures via amine-catalyzed thiol, or a polycarbonate resin.
